(19) United States
(12) Patent Application Publication
(10) Pub. No.: US 2004/0012923 A1
(43) Pub. Date: Jan. 22, 2004

(54) Heat dissipation device

(76) Inventor: Yung-Shun Chen, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/237,413

(22) Filed: Sep. 9, 2002

(30) Foreign Application Priority Data
Jul. 17, 2002 (TW) 91210867

(51) Int. Cl. G06F 1/20

(52) U.S. Cl. 361/687

(57) ABSTRACT

A heat dissipation device. The heat dissipation device includes a housing and a blade. The housing has a first side, a second side, a first surface and a second surface. The first side is adjacent to the second side. The first surface is opposite to the second surface. The first side and the second side are disposed between the first surface and the second surface. The first side has a first outlet, the second side has a second outlet, the first surface has a first intake, and the second surface has a second intake. The blade is disposed in the housing and between the first intake and the second intake. The blade takes in air from the first intake and the second intake and expels the air via the first outlet and the second outlet.

### BACKGROUND OF THE INVENTION

1. Field of the Invention

The present invention relates to a heat dissipation device, and in particular to a heat dissipation device reducing the temperature of the keyboard and inner electronic components of a portable computer.

2. Description of the Related Art

In a conventional portable computer, heat generated by the CPU is dissipated by a fan. In addition, other electronic components also generate heat. Thus, another fan is disposed in the portable computer to reduce the temperature of the electronic components, enhancing heat dissipation.

Nevertheless, in the conventional portable computer having limited inner space, two fans affect the arrangement of other components, thus increasing the volume and weight of the portable computer.

Consequently, the invention provides a heat dissipation device having specific airflow intakes and outlets to enhance heat dissipation without affecting the useful inner space of the portable computer. The invention reduces the temperature of the CPU and electronic components. Furthermore, the invention reduces the temperature of the keyboard.

### SUMMARY OF THE INVENTION

An object of the invention is to provide a heat dissipation device. The heat dissipation device comprises a housing and a blade. The housing has a first side, a second side, a first surface and a second surface. The first side is adjacent to the second side, the first surface is opposite to the second surface, and the first side and the second side are disposed between the first surface and the second surface. The first side has a first outlet, the second side has a second outlet, the first surface has a first intake, and the second surface has a second intake. The first intake is opposite to the second intake.

The blade is disposed in the housing and between the first intake and the second intake. The blade takes in air from the first intake and the second intake and expels the air via the first outlet and the second outlet.

Preferably, the first outlet is larger than and adjacent to the second outlet.

Preferably, the heat dissipation device is a blower-type fan, in which the outflow is substantially perpendicular to the intake.

Preferably, the first intake and the second intake are circular.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic top view showing the heat dissipation device of the invention;

FIG. 1B is a schematic bottom view showing the heat dissipation device of the invention; and

FIG. 2 is a schematic view showing a portable computer using the heat dissipation device of the invention.

### DETAILED DESCRIPTION OF THE INVENTION

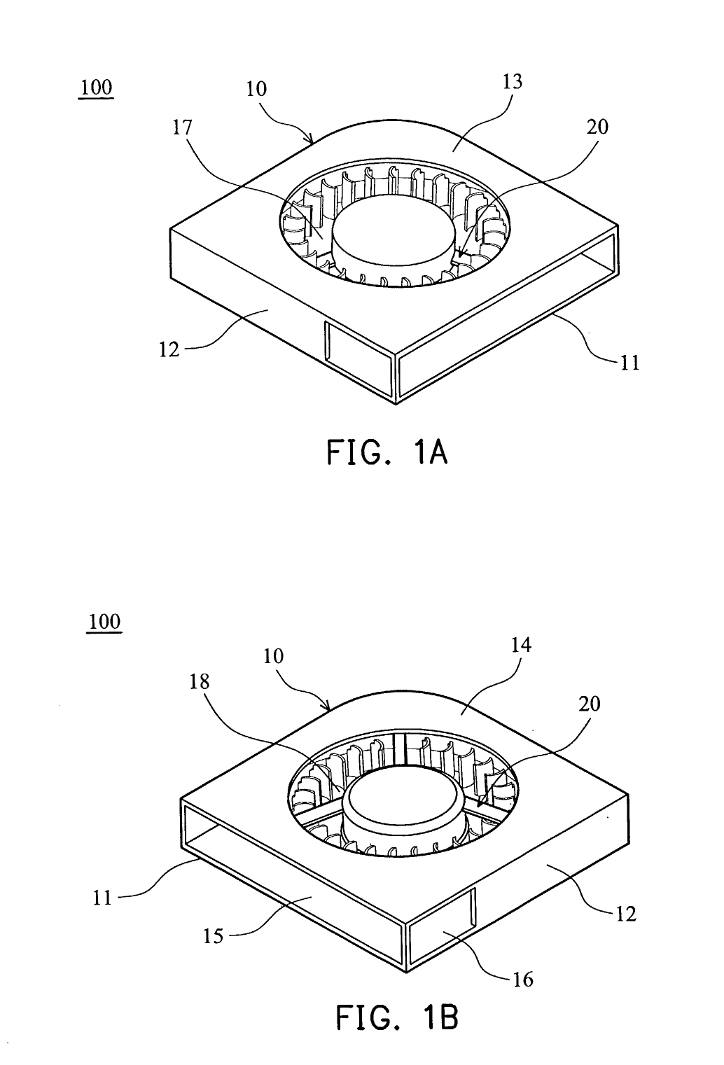

Referring to FIG. 1A and FIG. 1B, the heat dissipation device 100 includes a housing 10 and a blade 20.

The housing 10 has a first side 11, a second side 12, a first surface 13 and a second surface 14. The first side 11 is adjacent to the second side 12. The first surface 13 is opposite to the second surface 14. The first side 11 and the second side 12 are disposed between the first surface 13 and the second surface 14. The first side 11 has a first outlet 15. The second side 12 has a second outlet 16. The first surface 13 has a first intake 17. The second surface 14 has a second intake 18. The first intake 17 is opposite to the second intake 18.

The blade 20 can be any dimension and any type, in which the outflow is substantially perpendicular to the intake, and is disposed in the housing 10 and between the first intake 17 and the second intake 18. The blade 20 takes in air from the first intake 17 and the second intake 18 and expels the air via the first outlet 15 and the second outlet 16. Additionally, the blade 20 has a spindle perpendicular to the first surface 13 and the second surface 14.

As shown in FIG. 1A and FIG. 1B, the first outlet 15 is larger than the second outlet 16, and the first outlet 15 is adjacent to the second outlet 16. After the blade 20 takes in air via the first intake 17 and/or the second intake 18, the air is expelled mostly via the first outlet 15. The second outlet 16 is an auxiliary outlet. The airflow from the first outlet 15 cools a heat sink (not shown) while the airflow from the second outlet 16 cools a CPU or other electronic components. Thus, the heat dissipation device 100 having the first outlet 15 and the second outlet 16 provides sufficient airflow to enhance heat dissipation for a system.

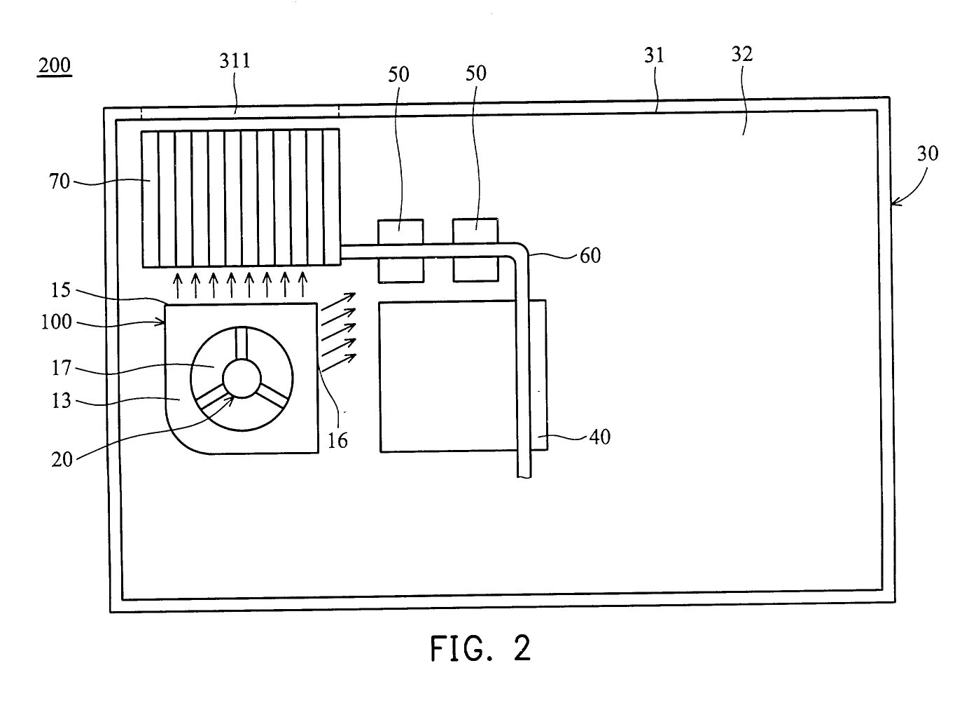

Referring to FIG. 2, the heat dissipation device 100 is disposed in the mainframe 200 of a portable computer. The mainframe 200 comprises a casing 30, a CPU 40, chipsets 50, a heat-conducting pipe 60, a heat sink 70 and a heat dissipation device 100. Additionally, a keyboard (not shown) is disposed on the mainframe 200.

The casing 30 has a third side 31 and a fourth side 32. The third side 31 is adjacent to the fourth side 32. The third side 31 has a third outlet 311 and the fourth side 32 has a third intake (not shown). The fourth side 32 is the bottom of the casing 30. The heat sink 70 faces the third outlet 311, and the second intake 18 of the heat dissipation device 100 faces the third intake. Additionally, the second side 12 of the heat dissipation device 100 faces the CPU 40 and the chipsets 50.

The heat-conducting pipe 60 is connected to the CPU 40, the chipsets 50 and a metal thermal plate (not shown) disposed under the heat sink 70. Thus, heat generated by the CPU 40, the chipsets 50 and other electronic components can be transmitted to the heat sink 70 via the heat-conducting pipe 60.

As described above, the heat generated by the CPU 40, the chipsets 50 and other electronic components can be transmitted to the heat sink 70 via the heat-conducting pipe 60 when the mainframe 200 is working. The blade 20 takes in air via the first intake 17 and/or the second intake 18. Namely, airflow enters the housing 10 via the upper and lower surfaces of the heat dissipation device 100. Then, the majority of the airflow passes through the heat sink 70 via the first outlet 15 and exits via the third outlet 311 of the casing 30, while the remainder flows to the CPU 40 via the second outlet 16 to assist in cooling the CPU 40.

Specifically, the third outlet 311 and the third intake are holes having railings.

The present heat dissipation device 100 also has another advantage. The surface temperature of the keyboard can be reduced. Thus, a user can operate the portable computer more comfortably. As mentioned above, since air is taken in via the upper and lower surfaces of the housing 10, the hot air near the keyboard surface is also taken in. Then, the air is expelled via the first outlet 15. Thus, the surface temperature of the keyboard is reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A heat dissipation device, comprising:
a housing having a first side, a second side and a surface, the first side adjacent to the second side, both the first side and the second side connecting the surface, the first side having a first outlet, the second side having a second outlet, the surface having an intake; and
a blade disposed in the housing, the blade taking in air from the intake and expelling the air via the first outlet and the second outlet.

2. The heat dissipation device as claimed in claim 1, wherein the first outlet is larger than the second outlet, and the first outlet is adjacent to the second outlet.

3. The heat dissipation device as claimed in claim 1, wherein the outflow is substantially perpendicular to the intake.

4. The heat dissipation device as claimed in claim 1, further comprising a spindle perpendicular to the first surface and the second surface.

5. The heat dissipation device as claimed in claim 1, wherein the first intake and the second intake are circular.

6. A heat dissipation device, disposed in a computer with a casing, an electronic component, a heat sink and a heat-conducting pipe, wherein the electronic component and the heat sink are disposed in the casing, and the heat-conducting pipe connects the electronic component and the heat sink, the heat dissipation device comprising:
a housing with a first side, a second side, a first surface and a second surface, the first side adjacent to the second side, the first surface opposite to the second surface, the first side and the second side disposed between the first surface and the second surface, the first side having a first outlet, the second side having a second outlet, the first surface having a first intake, the second surface having a second intake, wherein the first outlet facing the heat sink, and the second outlet facing the electronic component; and
a blade disposed in the housing and between the first intake and the second intake, the blade taking in air from the first intake and the second intake and expelling the air via the first outlet and the second outlet.

7. The heat dissipation device as claimed in claim 6, further comprising a metal thermal plate disposed under the heat sink.

8. The heat dissipation device as claimed in claim 7, wherein the heat-conducting pipe is connected to the electronic component and the metal thermal plate disposed under the heat sink.

9. The heat dissipation device as claimed in claim 6, wherein the blade is disposed in the housing and between the first intake and the second intake, the blade taking in air from the first intake and the second intake and expelling the air via the first outlet and the second outlet.

10. The heat dissipation device as claimed in claim 6, wherein the first outlet is larger than the second outlet, and the first outlet is adjacent to the second outlet.

11. The heat dissipation device as claimed in claim 6, wherein the outflow is substantially perpendicular to the intake.

12. The heat dissipation device as claimed in claim 6, further comprising a spindle perpendicular to the first surface and the second surface.

13. The heat dissipation device as claimed in claim 6, wherein the first intake and the second intake are circular.

14. The heat dissipation device as claimed in claim 6, wherein the casing further comprises a third side and a fourth side, the third side adjacent to the fourth side, the third side having a third outlet, the fourth side having a third intake.

15. The heat dissipation device as claimed in claim 14, wherein the heat sink faces the third outlet, and the second side of the housing faces the electronic component.

16. The heat dissipation device as claimed in claim 14, wherein the second intake faces the third intake of the fourth side.

17. The heat dissipation device as claimed in claim 14, wherein the third outlet and the third intake are holes having railings.
